(19) United States
(12) Patent Application Publication
(10) Pub. No.: US 2007/0130309 A1
(43) Pub. Date: Jun. 7, 2007

(54) Apparatus and method for dynamically binding binary code and virtual forwarding component of network processor

(76) Inventors: Hyun Jeong Yun, Daejeon (KR); Kyeong Hwan Doo, Daejeon (KR); Kwang Suk Song, Daejeon (KR); Bong Tae Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/503,599

(22) Filed: Aug. 14, 2006

(30) Foreign Application Priority Data
Dec. 2, 2005 (KR) 2005-0117032

(51) Int. Cl. G06F 15/173

(52) U.S. Cl. 709/223

(57) ABSTRACT

The present apparatus classifies the network system into a forwarding plane and a control plane, arranges a service combination controller at the control plane, arranges a service connection agent at the forwarding plane, and defines an application program and a binary code of a network processor as a component for each service. Therefore, if a new service addition request occurs in the system, the service combination controller transmits a service addition message to the service connection agent of the forwarding plane, and the service connection agent performs a binding process between the pre-defined functional component and the binary code of a network processor. If a new service request associated with a device including a specific network service occurs, only the new service function is added to a common platform, such that the resultant system can be made commercially available, resulting in reduction of a product development time.

### RELATED APPLICATIONS

The present application is based on, and claims priority from, Korean Application Number 2005-0117032, filed Dec. 2, 2005, the disclosure of which is incorporated by reference herein in its entirety.

### BACKGROUND OF THE INVENTION

1. Field of the Invention

The present invention relates to a network system, and more particularly to a programmable router and an active network system which are capable of adding a new service module to a common platform upon receiving a new service request associated with a device equipped with a specific network service, or deleting an unnecessary service module from the common platform when a user desires to delete the unnecessary service.

2. Description of the Prior Art

Generally, if a user desires to modularize a specific network service and desires to introduce a new network service to a network device, a network system has been rapidly developed to a customized network system capable of adding or deleting a necessary module to/from a system according to the new network service. Most network systems have been designed to have customized structures in association with a specific network service. Therefore, if a user desires to introduce a new network service to the network system, the system must be re-customized according to the new network system.

Specifically, a dynamic binding processing technology between a binary code of a network processor and a pre-defined application program component is requisite to modularize individual functions of the network system. There has recently been researched a soft-switch technology for constructing the application program in the form of a component, and hierarchically assembling the component. However, it is difficult to apply the above-mentioned soft-switch technology to the network system equipped with a network processor.

Therefore, a control plane component and a forwarding plane component of the network processor must be newly developed and added to the network system whenever a new service is added to the network system, such that a long period of time elapses to develop the above-mentioned plane components, and a large number of research workers must conduct intensive research into the improved network system.

### SUMMARY OF THE INVENTION

The present invention provides an apparatus and method for performing a dynamic binding process using a dynamic binding technology between a binary code of a network processor and an application program component, such that the apparatus and method can be applied to a network system using the network processor.

In accordance with one aspect of the present invention, the above and other objects can be accomplished by the provision of an apparatus for dynamically binding a binary code of a network processor and a virtual forwarding component comprising: a service combination controller for dividing corresponding sources into an application program and a binary code of each network processor if a service addition request for adding a new service to a network system equipped with a plurality of distributed network processors or a service deletion request for deleting a conventional service from the network system occurs, configuring each of the application program and the binary code in the form of a component, transmitting a message indicating the presence of a new component, and loading the application program component upon receiving a response to the message; a forwarding controller acting as a master for the divided network processors; and an application program component database for storing an overall application program component operated in each network processor.

Preferably, the apparatus further comprises: a switch fabric backplane which provides a communication channel interface capable of transmitting the message received from the service combination controller.

Preferably, the service combination controller is configured in the form of an independent server.

Preferably, the message includes a destination address, a source address, a protocol type, a network processor number, a component data size, a service type, and component data.

In accordance with another aspect of the present invention, there is provided an apparatus for dynamically binding a binary code of a network processor and a virtual forwarding component comprising: N network processor component databases for storing binary code components of a plurality of distributed network processors for use in a network system equipped with the distributed network processors; N service connection agents, each of which receives a message associated with the configuration of a new component, analyzes the message, and loads a component upon receiving a new service addition request or a conventional service deletion request; N dynamic binders, each of which determines whether the component loaded by the new service addition request is contained in the network processor component databases, transmits a message capable of activating the binary code component corresponding to the network processor when the loaded component is contained in the network processor component databases, and stores the binary code component in the network processor component databases and loads the stored binary code component on the network processor when the loaded component is not contained in the network processor component databases; and N network processor forwarding controllers, each of which performs overall control operations of each network processor.

Preferably, the apparatus further comprises: a switch fabric backplane which provides a communication channel interface capable of transmitting the message received from each service connection agent.

Preferably, the N dynamic binders determine whether the binary code component loaded by the conventional service deletion request is contained in the network processor component databases, and transmit a message capable of inactivating the binary code component corresponding to the network processor when the loaded binary code component is contained in the network processor component databases.

In accordance with yet another aspect of the present invention, there is provided a method for dynamically binding a binary code of a network processor and a virtual forwarding component comprising the steps of: a) if a new service addition request or a service deletion request occurs in a virtual forwarding platform, allowing a service combination controller to generate both an application program component to be arranged at a control plane associated with the service and a network processor's binary code component; b) generating a message equipped with service type information to individual service connection agents after the application program component and the binary code component have been generated, and transmitting the message; c) allowing the individual service connection agents to analyze the received message, and searching for a network processor component database using a component identifier (ID); and d) transmitting a binary code activation command of a corresponding component to a network processor after the corresponding component ID has been found.

Preferably, the method further comprises the steps of: e) if the corresponding component ID is not found so that there is no source data corresponding to the service, adding a new entry to the network processor component database using the corresponding component ID as a key value; f) reloading a service corresponding to the added entry using a binary code; and g) if the service reloading is completed, performing rebooting to initialize the network processor.

Preferably, the method further comprising the step of: if the binary code component of the network processor is completely activated, allowing the individual service connection agents to inform the service combination controller of the result of a dynamic binding.

Preferably, the method further comprises the steps of: if the service deletion request occurs in a network system, allowing the service combination controller to search for a corresponding service in a component database associated with the service; transmitting application program component information to be deleted to a control plane; generating a message indicating binary code component deletion, and transmitting the message to a service agent of a forwarding plane; allowing each of the service connection agents to analyze the received message, and searching for a network processor component database using the component ID; and transmitting a binary code inactivation command of the corresponding component to a network processor after the corresponding component ID has been found.

Preferably, the method further comprises the step of: allowing each of the service connection agents to inform the service combination controller of the result of a dynamic binding release after the binary code component of the network processor has been completely inactivated.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a network system using a network processor according to the present invention;

FIG. 2 is a detailed functional block diagram illustrating individual components of the network system shown in FIG. 1 according to the present invention;

FIG. 3 is a block diagram illustrating a virtual network processor platform according to a preferred embodiment of the present invention;

FIG. 4 is a structural diagram illustrating a message format between a service combination controller and a service connection agent according to the present invention;

FIG. 5 is a flow chart illustrating a method for performing a dynamic binding process of a binary code when a new service is added to a network system according to a preferred embodiment of the present invention; and

FIG. 6 is a flow chart illustrating a method for performing a dynamic binding process of a binary code when a service is deleted from a network system according to a preferred embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

A dynamic binding processing apparatus according to the present invention classifies an internal part of a system into a forwarding plane and a control plane, arranges a service combination controller at the control plane, arranges a service connection agent at the forwarding plane, and defines an application program and a binary code of a network processor as a component for each service. Therefore, if a new service addition request occurs in the system, the service combination controller transmits a service addition message to the service connection agent of the forwarding plane, and the service connection agent performs a binding process between the pre-defined functional component and the binary code of a network processor. A detailed description of the present invention will hereinafter be described with reference to the annexed drawings.

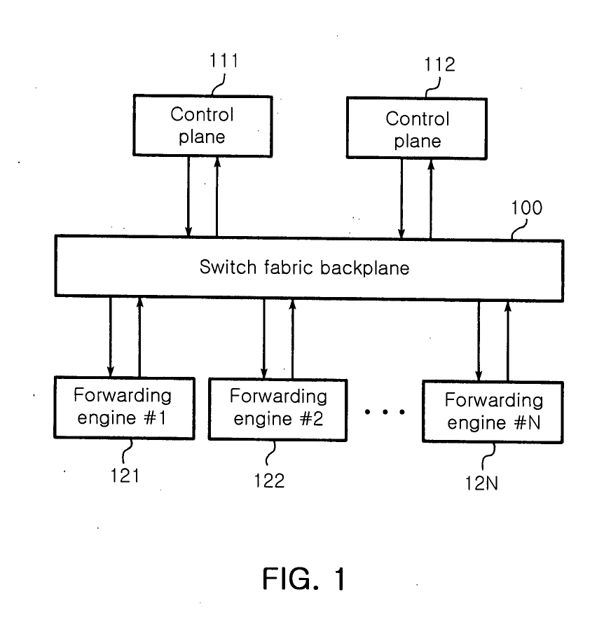

FIG. 1 is a block diagram illustrating a network system using a network processor according to the present invention.

Referring to FIG. 1, the network system is mainly classified to a plurality of control planes 111 and 112 and a plurality of forwarding planes 121 and 122˜12N. The control planes 111 and 112 perform processing of a protocol associated with control operations of the network system, and manage the network system. The forwarding planes 121 and 122˜12N perform forwarding of packets to a corresponding destination. The control planes are connected to the forwarding planes via a switch fabric backplane 100.

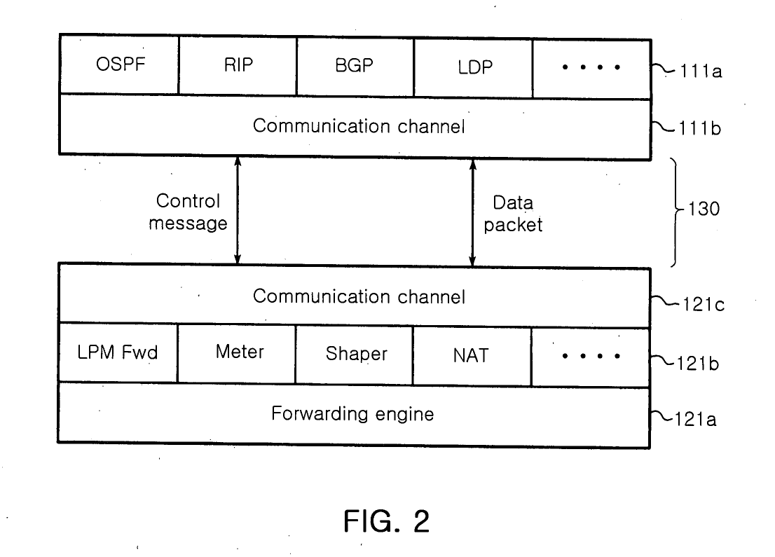

Individual planes of the above-mentioned network system will hereinafter be described with reference to FIG. 2.

FIG. 2 is a detailed functional block diagram illustrating individual components of the network system shown in FIG. 1 according to the present invention.

Referring to FIG. 2, the control planes 111 and 112 control individual network processors, respectively. Each control plane 111 or 112 includes a routing protocol, a signaling protocol, and system management modules 111a.

The routing protocol block includes a plurality of protocol processors, i.e., an Open Shortest Path First (OSPF), a Routing Information Protocol (RIF), a Boarder Gateway Protocol (BGF), and a Label Distribution Protocol (LDP), etc.

The OSPF is indicative of a routing protocol used at a time earlier than the RIP in a large-scale autonomous network. Similar to the RIP, the OSPF is defined as one of several IGPs by IETF. If a host recognizes the change of a routing table or a certain change within the network, it immediately informs other hosts contained in the network of the recognized change information using the above-mentioned OSPF, such that the aforementioned hosts can have the same routing information. The host, which uses the OSPF differently from the RIP transmitting the entire routing table, transmits only the changed part. The RIP transmits the routing table to a neighboring host at intervals of a predetermined time (i.e., 30 seconds). However, the OSPF multicasts changed information only when the changed information occurs.

Each of the forwarding planes 121˜12N includes a network processor equipped with a binary code for the packet processing and an agent for the system management. The relationship between a control plane and a forwarding plane is generally denoted by 1:N or N:M. In this case, the relationship between the control plane and the forwarding plane is 2:N, and a communication channel 130 is located between the control plane and the forwarding plane, such that the communication channel 130 can transmit a data packet to an external system or can perform control message communication between the control plane and the forwarding plane.

The LPM FWD block shown in FIG. 2 performs the longest prefix matching method to search for an Internal Protocol (IP) address. In more detail, the LPM FWD block compares entry information contained in the routing table with a packet IP address during a path selection process, selects an entry which is most frequently equal to the packet IP address from among a plurality of entries, and performs forwarding of the selected entry.

The Meter block of FIG. 2 measures temporal characteristics of a packet stream selected by a packet classifier so as to determine if a traffic profile prescribed in the TCA is preserved. The Meter block transmits status information to other traffic control functions in order to properly process an in-profile packet or an out-of-profile packet.

The shaper block of FIG. 2 delays some packets or all packets contained in a traffic stream, such that the stream can preserve a traffic profile. The shaper block generally includes a limited-sized buffer. If the buffer space is too small to accommodate the delayed packet, the shaper block discards the delayed packets.

The Network Address Translation (NAT) block of FIG. 2 performs IP address translation in an internal network which uses an IP address different from that of an external network.

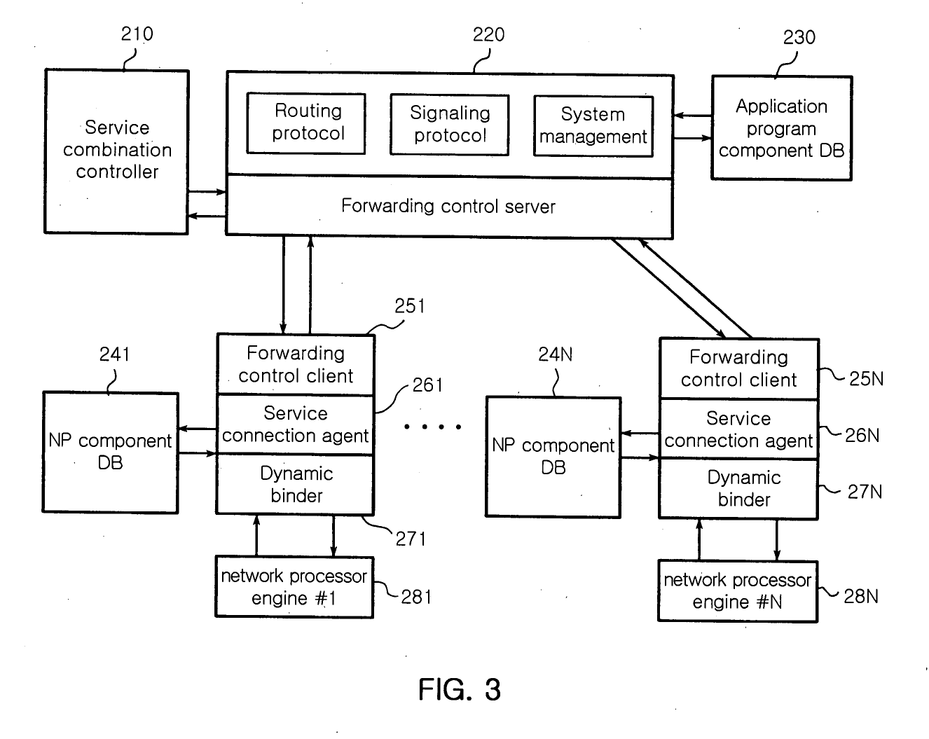

FIG. 3 is a block diagram illustrating a virtual network processor platform according to a preferred embodiment of the present invention.

Referring to FIG. 3, a virtual network processor platform includes a service combination controller 210, a forwarding control server 220, an application program component database 230, N network processor component databases 241˜24N, N forwarding control clients 251˜25N, N service connection agents 261˜26N, N dynamic binders 271˜27N, and N network processor engines 281˜28N.

Upon receiving a request for adding a new service to a system or a request for deleting a specific service from the system, the service combination controller 210 divides corresponding sources into an application program and a binary code of a network processor, configures each of the application program and the binary code in the form of a component, and transmits a message indicating the presence of a new component to the service connection agents 261˜26N.

Thereafter, upon receiving a response from the service connection agents 261˜26N, the service combination controller 210 allows the control plane to load a corresponding application program from the application program component database 230, and allows the forwarding plane to load a network processor binary code from the network processor component databases 241˜24N. The service combination controller 210 may be used as an independent server or a part of the control plane. However, if the service combination controller is in the control plane, it is desirable that the service combination controller 210 includes the service connection agent function.

The service connection agents 261˜26N receive a message from the service combination controller 210, and analyze requirements on the basis of the received message. If there is a service addition request, the service connection agents 261˜26N receive a corresponding component. The message transmission/reception between the service combination controller 210 and the service connection agents 261˜26N is established over a communication channel between the forwarding control server 220 and a client.

The dynamic binders 271˜27N determine whether the component loaded from the service connection agents 261˜26N is contained in the network processor databases 241˜24N. If the presence of the loaded component is determined, the dynamic binders 271˜27N transmit a message for activating a corresponding component to network processor engines 281˜28N. Otherwise, if the absence of the loaded component is determined, the dynamic binders 271˜27N store the components loaded from the service connection agents in a database, and load the component on the network processor.

Generally, the dynamic binding is referred to as a Late Binding. The dynamic binding occurs according to status information generated when a routine or an object linking is executed. As for variables for a programming process, a method for storing/manipulating a value stored in the variables is changed according to shape information of an integer or string. Although typical compilers or assemblers provide a static binding capable of allocating a variable type at a compiling time, object-oriented languages support a dynamic binding capable of determining a variable type at a specific time at which the value generated from a keyboard or other sources is received in the variable. The dynamic binding is contrary to an early binding or a static binding.

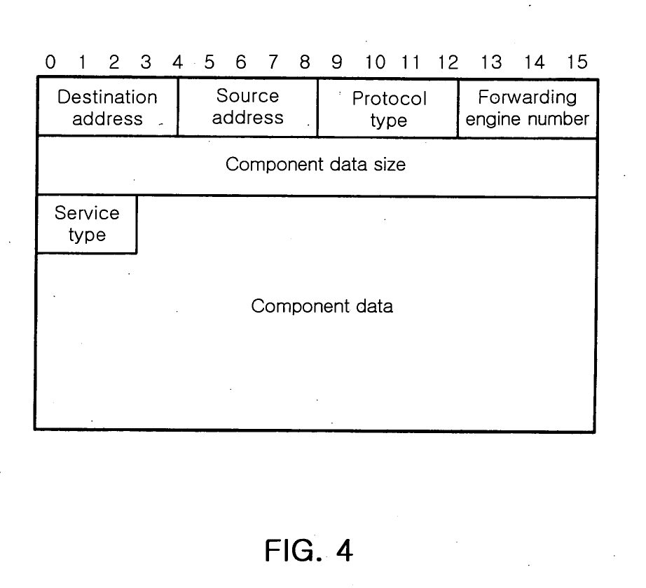

FIG. 4 is a structural diagram illustrating a message format between a service combination controller and a service connection agent according to the present invention. The service combination controller and the service connection agent may use the Ethernet to provide a communication channel between the forwarding control server and the client.

The message communicated between the service combination controller and the service connection agent includes an Ethernet header field. The Ethernet header field includes a destination address field, a source address field, a protocol type field, and a forwarding number field. According to the value of a service type field, it can be determined whether a component associated with a corresponding service is added, deleted, or changed. The component data size field is indicative of a variable length for each service, and the value of the variable length can be recognized by the service length field.

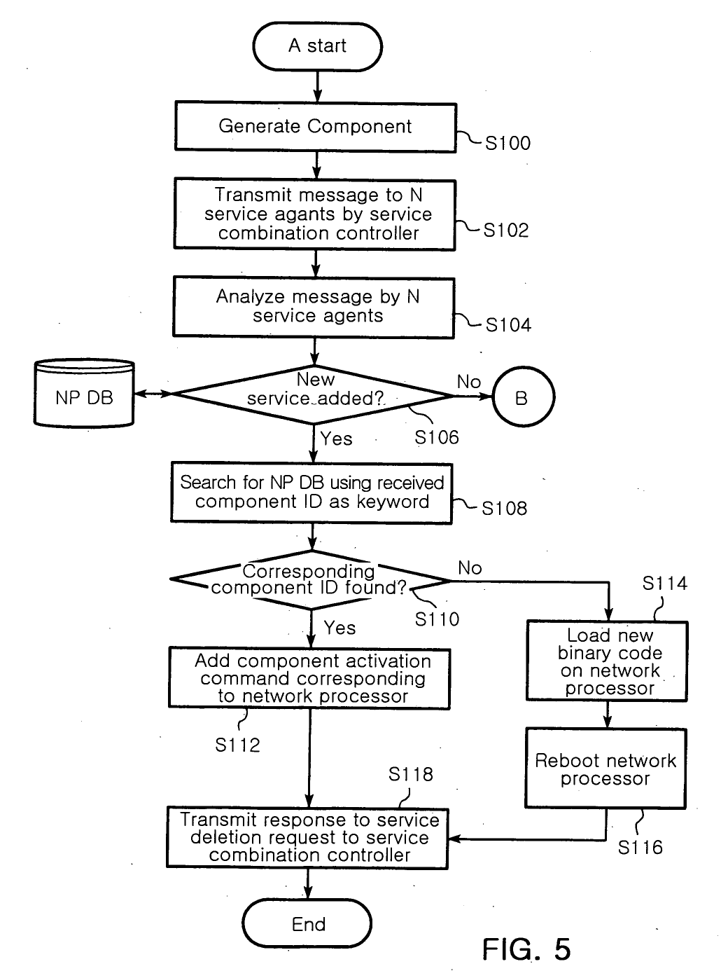

FIG. 5 is a flow chart illustrating a method for performing a dynamic binding process of a binary code when a new service is added to a network system according to a preferred embodiment of the present invention. In more detail, if a new service addition request is generated from a virtual forwarding platform, a dynamic binding processing method of the application program and the network-processor binary code is shown in FIG. 5.

Referring to FIG. 5, a system administrator indicates that a new service addition request is contained in the virtual forwarding platform using the service combination controller 210. The service combination controller 210 generates not only an application program component to be arranged at the control plane associated with the service, but also a network-processor binary code component at step S100. If the above-mentioned components are generated at step S100, the service combination controller 210 generates a message including service type information, and transmits the message to N service connection agents 261˜26N at step S102. The service connection agents 261˜26N analyze the message at step S104, and determine whether a new service is added or a conventional service is deleted at step S106.

If the service deletion is determined, the service connection agents perform the B routine. If the service addition is determined, the service connection agents analyze the received message, and search for the network processor database (NP DB) using a component ID (identifier) at step S108. If the service connection agents search for the corresponding component ID at step S110, the service connection agents transmit a binary code activation command of the corresponding component to the network processor at step S112. If the service connection agents fail to search for the corresponding component ID at step S110, there is no source data corresponding to the service. Therefore, a new entry is added to the NP DB using the corresponding component ID as a key value, and a corresponding binary code is re-loaded at step S114, such that the source data corresponding to the service can be added. If the binary-code loading is completed at step S114, the service connection agents perform rebooting to initialize the network processor at step S116. If the binary code component of the network processor is completely activated, the service connection agents inform the service combination controller 210 of the dynamic binding result at step S118.

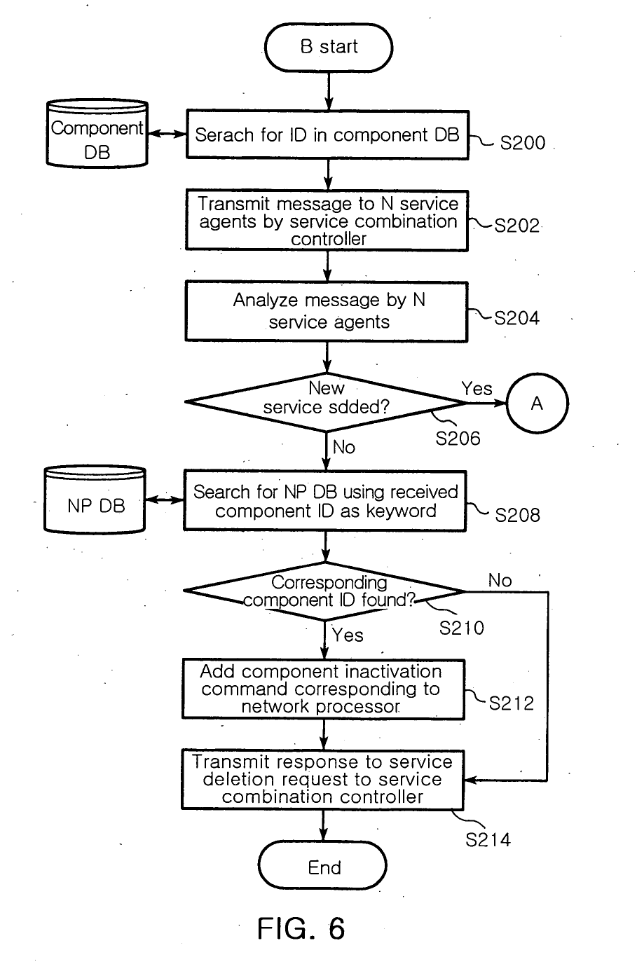

FIG. 6 is a flow chart illustrating a method for performing a dynamic binding process of a binary code when a service is deleted from a network system according to a preferred embodiment of the present invention.

Referring to FIG. 6, if a request for deleting a conventional service from the network system occurs, a system administrator indicates that the conventional service deletion request occurs in the virtual forwarding platform using the service combination controller 210.

The service combination controller 210 searches for a corresponding service from the service-associated component DB at step 200. The service combination controller 210 generates an application program component to be deleted in the control plane, generates a message indicating the deletion of the binary code component in the forwarding plane, and transmits the message to the service agent at step S202. Individual service connection agents 261˜26N analyze the message at step S204, and determine whether a new service is added or a conventional service is deleted at step S206.

If the service addition is determined, the service connection agents perform the A routine. If the service deletion is determined, the service connection agents analyze the received messages, and search for the network processor database (NP DB) using a component ID at step S208. If the service connection agents search for the corresponding component ID at step S210, a binary code inactivation command of the corresponding component is transmitted to the network processor at step S212. If the binary-code component inactivation procedure of the network processor is completed, individual service connection agents inform the service combination controller 210 of the dynamic binding release result at step S214.

As apparent from the above description, the dynamic binding processing apparatus and method according to the present invention classifies the network system into a forwarding plane and a control plane, arranges a service combination controller at the control plane, arranges a service connection agent at the forwarding plane, and defines an application program and a binary code of a network processor as a component for each service. Therefore, if a new service addition request occurs in the system, the service combination controller transmits a service addition message to the service connection agent of the forwarding plane, and the service connection agent performs a binding process between the pre-defined functional component and the binary code of a network processor. As a result, if a new service request associated with a device including a specific network service occurs, only the new service function is added to a common platform, such that the resultant system can be made commercially available, resulting in reduction of a product development time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for dynamically binding a binary code of a network processor and a virtual forwarding component comprising:
a service combination controller for dividing corresponding sources into an application program and a binary code of each network processor if a service addition request for adding a new service to a network system equipped with a plurality of distributed network processors or a service deletion request for deleting a conventional service from the network system occurs, configuring each of the application program and the binary code in the form of a component, transmitting a message indicating the presence of a new component, and loading the application program component upon receiving a response to the message;
a forwarding controller acting as a master for the divided network processors; and
an application program component database for storing an overall application program component operated in each network processor.

2. The apparatus according to claim 1, further comprising a switch fabric backplane which provides a communication channel interface capable of transmitting/receiving the message to/from the service combination controller.

3. The apparatus according to claim 1, wherein the service combination controller is configured in the form of an independent server.

4. The apparatus according to claim 1, wherein the message includes a destination address, a source address, a protocol type, a network processor number, a component data size, a service type, and component data.

5. An apparatus for dynamically binding a binary code of a network processor and a virtual forwarding component comprising:
N network processor component databases for storing binary code components of a plurality of distributed network processors for use in a network system equipped with the distributed network processors;
N service connection agents, each of which receives a message associated with the configuration of a new component, analyzes the message, and loads a component upon receiving a new service addition request or a conventional service deletion request;
N dynamic binders, each of which determines whether the component loaded by the new service addition request is contained in the network processor component databases, transmits a message capable of activating the binary code component corresponding to the network processor when the loaded component is contained in the network processor component databases, and stores the binary code component in the network processor component databases and loads the stored binary code component on the network processor when the loaded component is not contained in the network processor component databases; and
N network processor forwarding controller, each of which performs overall control operations of each network processor.

6. The apparatus according to claim 5, further comprising a switch fabric backplane which provides a communication channel interface capable of transmitting/receiving the message to/from each service connection agent.

7. The apparatus according to claim 5, wherein the N dynamic binders determine whether the binary code component loaded by the conventional service deletion request is contained in the network processor component databases, and transmit a message capable of inactivating the binary code component corresponding to the network processor when the loaded binary code component is contained in the network processor component databases.

8. A method for dynamically binding a binary code of a network processor and a virtual forwarding component comprising the steps of:
a) if a new service addition request or a service deletion request occurs in a virtual forwarding platform, allowing a service combination controller to generate both an application program component to be arranged at a control plane associated with the service and a network processor's binary code component;
b) generating a message equipped with service type information to individual service connection agents after the application program component and the binary code component have been generated, and transmitting the message;
c) allowing the individual service connection agents to analyze the received message, and searching for a network processor component database using a component identifier (ID); and
d) transmitting a binary code activation command of a corresponding component to a network processor after the corresponding component ID has been found.

9. The method according to claim 8, further comprising the steps of:
e) if the corresponding component ID is not found so that there is no source data corresponding to the service, adding a new entry to the network processor component database using the corresponding component ID as a key value;
f) reloading a service corresponding to the added entry using a binary code; and
g) if the service reloading is completed, performing rebooting to initialize the network processor.

10. The method according to claim 8, further comprising the step of:
if the binary code component of the network processor is completely activated, allowing the individual service connection agents to inform the service combination controller of the result of a dynamic binding.

11. The method according to claim 8, further comprising the steps of:
h) if the service deletion request occurs in a network system, allowing the service combination controller to search for a corresponding service in a component database associated with the service;
i) transmitting application program component information to be deleted to a control plane;
j) generating a message indicating binary code component deletion, and transmitting the message to a service agent of a forwarding plane;
k) allowing each of the service connection agents to analyze the received message, and searching for a network processor component database using the component ID; and
l) transmitting a binary code inactivation command of the corresponding component to a network processor after the corresponding component ID has been found.

12. The method according to claim 11, further comprising the step of allowing each of the service connection agents to inform the service combination controller of the result of a dynamic binding release after the binary code component of the network processor has been completely inactivated.
